(19) United States
(12) Patent Application Publication
(10) Pub. No.: US 2005/0191151 A1
(43) Pub. Date: Sep. 1, 2005

(54) Anti-rotation apparatus for use with threaded components

(76) Inventor: Doug Gethmann, Gladbrook, IA (US)

Correspondence Address: GROSSMAN & FLIGHT LLC, Suite 4220, 20 North Wacker Drive, Chicago, IL, 60606-6357, US

(21) Appl. No.: 10/851,538

(22) Filed: May 21, 2004

Related U.S. Application Data
(63) Continuation-in-part of application No. 10/790,524, filed on Mar. 1, 2004.

(51) Int. Cl. F16B 39/02

(52) U.S. Cl. 411/325

(57) ABSTRACT

An example anti-rotation apparatus includes a first member configured to be disposed within an aperture of an internally threaded component. The first member includes a first end having a recessed portion configured to receive a second member disposed within the aperture of the internally threaded component. The recessed portion of the first member is configured to receive the second member to cause a peripheral portion of the first end of the first member to frictionally engage a surface within the aperture of the internally threaded component.

### FIELD OF THE DISCLOSURE

The present disclosure relates generally to inhibiting or preventing rotation between threaded components and, more specifically, to anti-rotation apparatus that may be used to inhibit or prevent rotation between an internally threaded component such as an actuator rod and an externally threaded component such as a valve stem extension rod or the like.

### BACKGROUND

Process control plants often employ sliding stem type valves to control the flow of process fluids. A sliding stem valve typically includes a valve stem that extends from the body of the valve and which is coupled to an actuator via a stem connector. In general, the actuator (e.g., a pneumatic, an electric actuator, a hydraulic actuator, etc.) is responsive to a controller to stroke the valve stem (e.g., by moving the valve stem toward/away from the valve body) to vary an amount of fluid flowing through the valve.

In some cases, such as applications involving high temperature environments and applications requiring a bellows to surround the valve stem (e.g., when controlling toxic fluids), the valve and its actuator are separated by a greater distance than used in many other applications. To increase the distance between the valve and the actuator, an extension stem or rod is typically used to couple the valve stem to the actuator. One end of the extension stem or rod is typically coupled to the valve stem using a conventional stem connector. The other end of the extension stem or rod typically includes an externally threaded portion configured to engage with the internal threads of the actuator rod.

To prevent the extension stem from rotating with respect to the actuator rod after installation of the actuator on the valve, a locking mechanism such as one or more lock nuts, lock washers, clamps, etc. may be employed. However, for many applications such as, for example, those involving bellows noted above, only a limited amount of access to the point at which the actuator rod is coupled to the extension stem is provided. As a result, it is often very difficult to access the apparatus used to lock (i.e., prevent rotation of) the actuator rod relative to the extension stem with the tools used to adjust, fix or otherwise effect the locking apparatus.

### BRIEF DESCRIPTION OF THE DRAWINGS

FIG. 1A is a plan view of an example anti-rotation apparatus that may be used to inhibit or prevent rotation between an externally threaded component and an internally threaded component.

FIG. 1B is a side elevational view of the example anti-rotation apparatus of FIG. 1A.

FIG. 1C is a cross-sectional view of the example anti-rotation apparatus of FIGS. 1A and 1B.

FIG. 2 is a cross-sectional view depicting one manner in which the example anti-rotation apparatus of FIG. 1 may be used to inhibit or prevent rotation between an externally threaded component and an internally threaded component.

FIG. 3A is a plan view of another example anti-rotation apparatus that may be used to inhibit or prevent rotation between an externally threaded component and an internally threaded component.

FIG. 3B is a side elevational view of the example anti-rotation apparatus of FIG. 3A.

FIG. 3C is a cross-sectional view of the example anti-rotation apparatus of FIGS. 3A and 3B.

FIG. 4 is a cross-sectional view depicting one manner in which the example anti-rotation apparatus of FIG. 3 may be used to inhibit or prevent rotation between an externally threaded component and an internally threaded component

### SUMMARY

In one example embodiment, an anti-rotation apparatus includes a first member configured to be disposed within an aperture of an internally threaded component. The first member includes a first end having a recessed portion configured to receive a second member disposed within the aperture of the internally threaded component. The recessed portion of the first member is configured to receive the second member to cause a peripheral portion of the first end of the first member to frictionally engage a surface within the aperture of the internally threaded component.

In another example embodiment, an anti-rotation apparatus includes a substantially cylindrical body configured to be disposed within an internally threaded component. An end of the substantially cylindrical body includes a deformable portion having a reduced wall section thickness and configured to be driven radially outward by an externally threaded component to frictionally engage the internally threaded component.

### DETAILED DESCRIPTION

The example anti-rotation apparatus described herein enable an externally threaded component to be rotably locked to an internally threaded component without having to employ the use of known lock nuts, lock washers, or the like. More specifically, the anti-rotation apparatus described herein may be particularly useful to rotably lock an externally threaded shaft or rod to an internally threaded component such as another shaft, actuator rod, etc. In contrast to known anti-rotation apparatus such as lock nuts and lock washers, the anti-rotation apparatus described herein is disposed within the internally threaded component (i.e., is encased by the internally threaded component) and may be configured to eliminate the need for the tools (e.g., wrenches, screwdrivers, etc.) that are normally needed to rotably lock an internally threaded component to an externally threaded component.

More specifically, as described in greater detail below, the example anti-rotation apparatus includes a first member configured to be disposed within an internally threaded portion of a component and having a recessed portion configured to receive a second member disposed within the internally threaded portion of the component. As an externally threaded component is threaded into the internally threaded portion, the second member is driven against the recessed portion and at least a peripheral portion surrounding the recessed portion is driven against a surface of the internally threaded portion to frictionally engage the surface to inhibit or prevent the rotation of the internally threaded component relative to the externally threaded component.

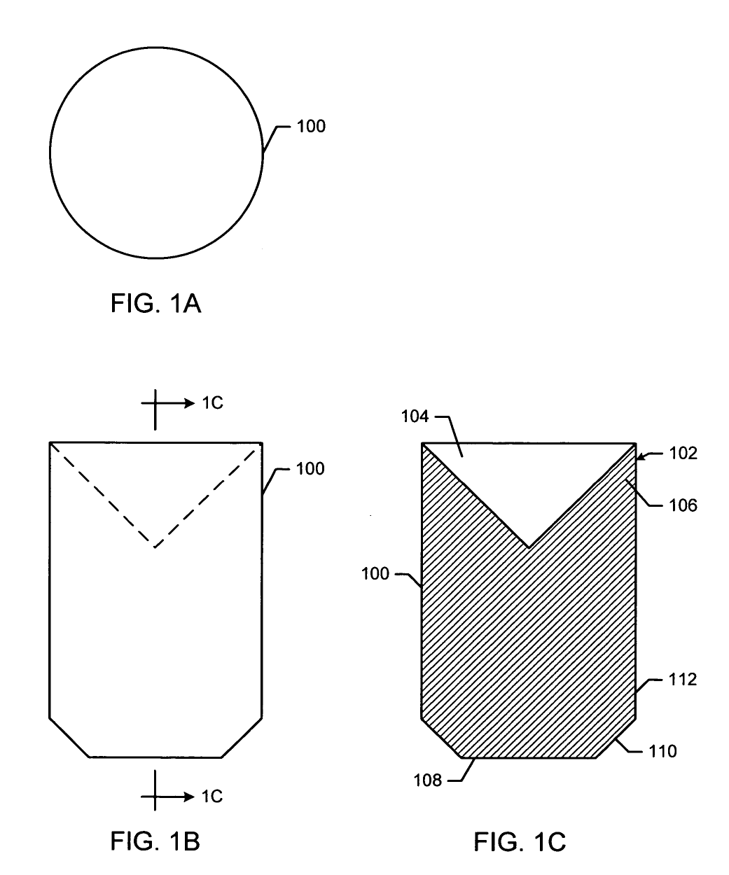

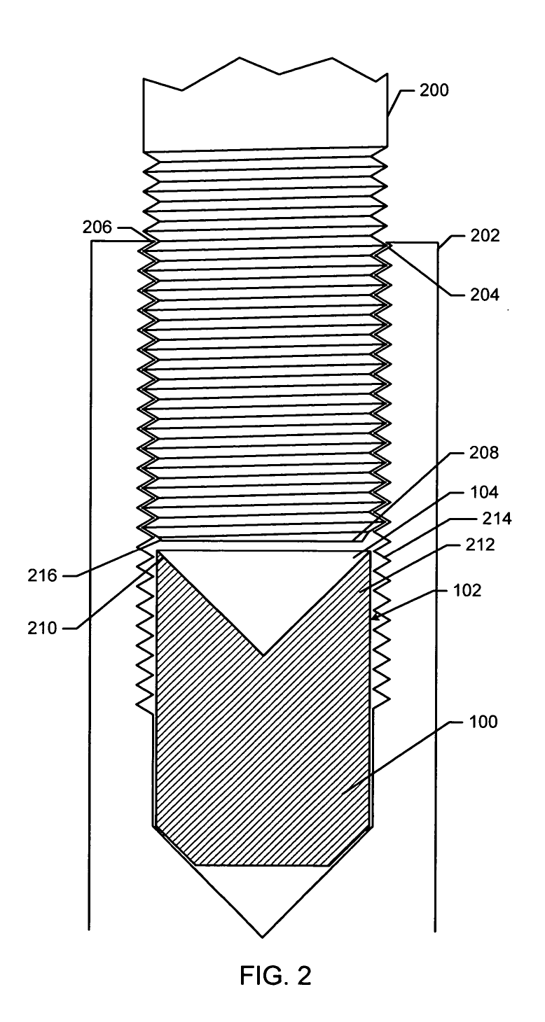

Now turning to FIGS. 1A, 1B and 1C an example anti-rotation apparatus 100 that may be used to inhibit or prevent the rotation of an externally threaded component relative to an internally threaded component is shown. As shown, the example anti-rotation apparatus 100 may be an elongate member or body having a substantially cylindrical shape. As described in greater detail in connection with FIG. 2 below, the anti-rotation apparatus 100 is preferably configured to be disposed within a cavity or aperture of an internally threaded component. For example, the anti-rotation apparatus 100 may be disposed within an internally threaded hole of a shaft, rod or the like associated with an actuator or any other device employing an internally threaded shaft, rod or other component.

As shown in FIG. 1C, the anti-rotation apparatus 100 has a first end 102 including a recessed portion 104. The recessed portion 104 may have a substantially concave tapered or cone-shaped geometry as depicted in FIG. 1C or any other shape or geometry suitable for receiving an end of a bolt, shaft, rod, etc. The reduced thickness of a wall 106 of the anti-rotation apparatus 100 at the first end 102 facilitates the outward movement of one or more portions of the wall 106 to frictionally engage a surface of a threaded aperture in which the anti-rotation apparatus 100 is disposed (e.g., as shown in FIG. 2). A second end 108 of the anti-rotation apparatus 100 may include a circumferential chamfered portion 110 that extends about an outer surface 112 of the anti-rotation apparatus 100.

FIG. 2 is a cross-sectional view depicting one manner in which the example anti-rotation apparatus 100 of FIG. 1 may be used to substantially rotably lock an externally threaded component 200 to an internally threaded component 202. Initially, the anti-rotation apparatus 100 may be dropped or otherwise disposed within a hole or aperture 204 of the internally threaded component 202 so that the recessed portion 104 faces toward an opening 206 of the hole or aperture 204. The externally threaded component 200, which may be, for example, a threaded end of a bolt or rod, is threaded into the hole or aperture 204. As the externally threaded component 200 is threaded into the hole or aperture 204, an end 208 of the externally threaded component 200 drives against and frictionally engages a surface 210 within the recessed portion 104 to move an upper portion 212 of the first end 102 radially outward and into frictional engagement with a threaded surface 214 within the aperture 204 of the internally threaded component 202.

As can be seen in FIGS. 1 and 2, the upper portion 212 of the anti-rotation apparatus 100 has a reduced wall thickness (e.g., due to the tapered or cone-like shape of the recess 104), which enables the upper portion 212 of the anti-rotation apparatus 100 to deform in response to the end 208 of the externally threaded component 200 being driven against the surface 210 of the recessed portion 104. The frictional engagement of the end 208 of the externally threaded component 200 with the surface 210 of the recess and the upper portion 102 of the anti-rotation apparatus 100 against the surface 214 of the aperture 204 inhibits or prevents the rotation of (e.g., rotably locks) the externally threaded component 200 relative to the internally threaded component 202.

If desired, the upper portion 102 of the anti-rotation apparatus 100 may be configured to deform sufficiently so that the anti-rotation apparatus 100 remains captured (i.e., will not fall out and/or cannot be easily removed from the aperture 204) after being used (e.g., deformed) one time. However, the anti-rotation apparatus 100 may alternatively be configured to enable its removal after one or more uses.

As depicted in FIG. 2, the end 208 of the externally threaded component 200 preferably has a chamfered portion 216 to facilitate the frictional engagement between the end 208 of the externally threaded component 200 and the anti-rotation apparatus 100. In addition, the chamfered portion 216 may also facilitate the movement and/or deformation of the upper portion 102 in a radially outward direction with respect to a central or longitudinal axis. Those of ordinary skill in the art will recognize that some commonly available externally threaded components (e.g., stem extensions, shafts, bolts, etc.) are provided with a chamfered portion such as the portion 216 shown in FIG. 2. Also, in general, as the frictional contact point between the externally threaded component 200 and the anti-rotation apparatus 100 moves outward from the central or longitudinal axis, the ability of the anti-rotation apparatus 100 to inhibit or prevent relative rotation between the externally threaded component 200 and the internally threaded 202 component improves.

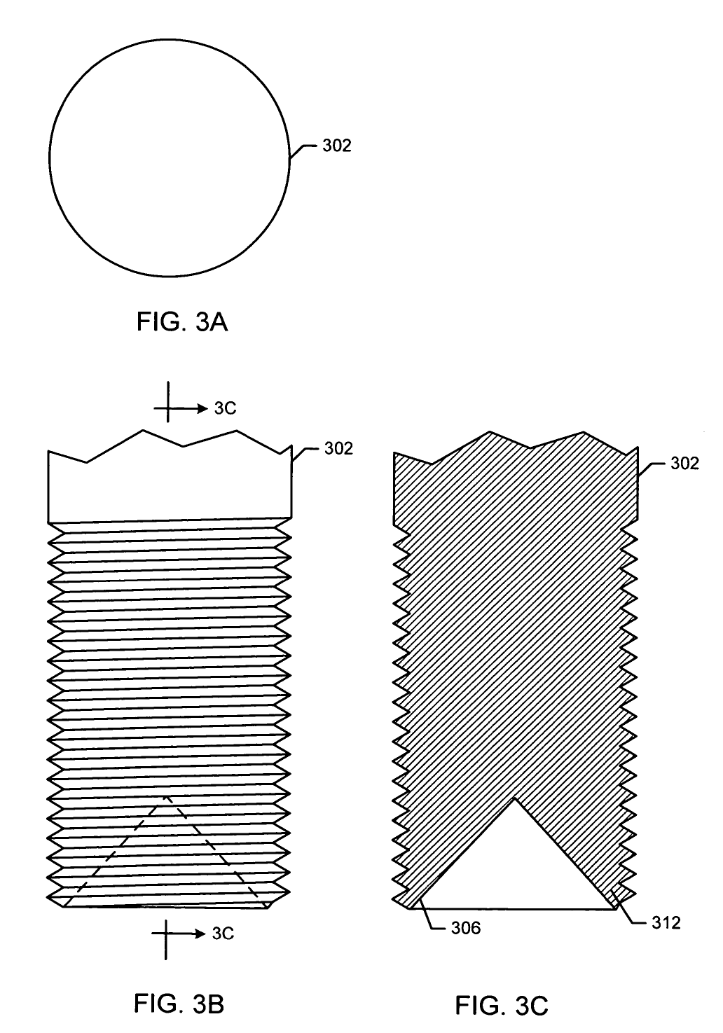

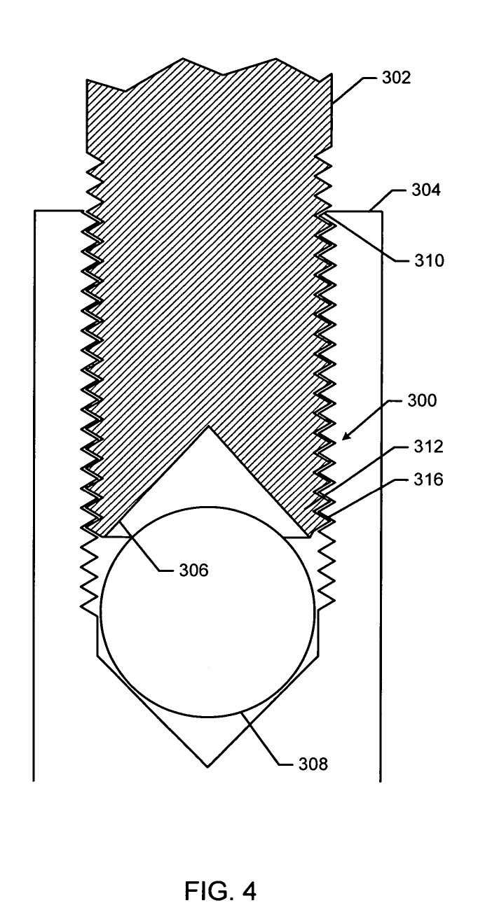

FIGS. 3 and 4 depict another example anti-rotation apparatus 300 that may be used to inhibit or prevent rotation between an externally threaded component 302 and an internally threaded component 304. In the example embodiment of FIGS. 3 and 4, the externally threaded component 302 includes a recessed portion 306 that drives against a substantially spherically-shaped member 308 disposed within an aperture 310 of the internally threaded component 304. Thus, similar to the embodiment shown in FIG. 2, as the externally threaded component 302 is threaded into the internally threaded component 304, a peripheral portion 312 proximate to the recessed portion 306 is driven outward from a central or longitudinal axis into frictional engagement with a surface 316 of the aperture 310.

The example anti-rotation apparatus described herein may be made using, for example, one or more metallic materials via any desired fabrication method. For example, the anti-rotation apparatus may be made using metallic material cut from commonly available smooth or threaded bar stock, a cast metal part, a sintered metal material, etc. One particularly useful material may be #316 stainless steel, which is commonly employed for use in making actuator rods, valve stems, etc. Further, to enhance the frictional engagement between the example anti-rotation apparatus described herein and the internally/externally threaded components, similar or identical materials may be used for these parts (i.e., the anti-rotation apparatus and the threaded components) to facilitate galling. Such galling between components made of like materials serves to significantly increase the friction between the components and, thus, the ability of the anti-rotation apparatus to inhibit or prevent rotation between the threaded components.

While the example anti-rotation apparatus described herein are depicted as being substantially cylindrically-shaped, shapes other than cylindrical may also be used. For example, generally polygonal shapes, shapes having a non-circular cross-section, etc. may be used instead. In any case, the shape or geometry of the anti-rotation apparatus is preferably complementary to the aperture into which the anti-rotation apparatus is intended to be disposed so that when the anti-rotation apparatus engages with another member (e.g., an end of a threaded bolt, a spherical member, etc.) a portion of the anti-rotation apparatus is driven radially outward to sufficiently frictionally engage a surface within the aperture.

The example anti-rotation apparatus described herein may be generally applied but may be particularly useful for inhibiting rotation or rotably locking an externally threaded component such as a shaft, a rod, a bolt, etc. to an internally threaded component such as, for example, another shaft or rod. Further, the example anti-rotation apparatus may be installed without requiring any tools such as those used to effect lock nuts and other known locking apparatus. Still further, in contrast to many known locking mechanisms (e.g., lock nuts, washers, etc.), the example anti-rotation apparatus described herein can be released from a substantially rotably locked or frictional engagement condition by rotating one of the threaded components relative to the other threaded component through a relatively small angle. As a result, the example anti-rotation apparatus described herein can substantially rotably lock an externally threaded component to another threaded component and can be easily unlocked or separated because the angle through which the frictional engagement is effective is relatively small (e.g., does not require transition through a large rotational angle under a highly frictional condition as is the case with some known lock nuts, lock washers, etc.)

Although certain apparatus have been described herein, the scope of coverage of this patent is not limited thereto. To the contrary, this patent covers all embodiments fairly falling within the scope of the appended claims either literally or under the doctrine of equivalents.

1-8. (canceled)

9. An anti-rotation apparatus, comprising:
a substantially cylindrical body configured to be disposed within an internally threaded component, wherein an end of the substantially cylindrical body includes a substantially permanently deformable portion having a reduced wall section thickness and configured to be driven radially outward by an externally threaded component to frictionally engage the internally threaded component, wherein the deformable portion includes a recess configured to receive an end of the externally threaded component.

10. An anti-rotation apparatus as defined in claim 9, wherein another end of the substantially cylindrical body includes a chamfered portion.

11. (canceled)

12. An anti-rotation apparatus as defined in claim 9, wherein the recess is substantially cone-shaped.

13. An apparatus as defined in claim 9, wherein the deformable portion is configured to be permanently deformed after being driven radially outward by the externally threaded component.

14. An apparatus as defined in claim 9, wherein the substantially cylindrical body is composed of a metallic material.

15. An apparatus as defined in claim 9, wherein each of the internally threaded component and the externally threaded component is one of a shaft and rod.

16. An anti-rotation apparatus, comprising:
a substantially non-elasticly deformable elongate metallic body configured to be disposed within an internally threaded component and having an end including a recess configured to receive an externally threaded component, wherein the end of the metallic body is configured to frictionally engage a surface within the internally threaded component when the externally threaded component is driven against at least a portion of the recess to radially deform the elongated metallic body and to inhibit the rotation of the externally threaded component relative to the internally threaded component.

17. An anti-rotation apparatus as defined in claim 16, wherein the recess is substantially cone-shaped.

18. An anti-rotation apparatus as defined in claim 16, wherein the at least the portion of the recess against which the externally threaded component is driven is proximate to a peripheral portion of the elongate metallic body.

19. An anti-rotation apparatus as defined in claim 16, wherein the elongate metallic body is substantially cylindrical.

20. An anti-rotation apparatus as defined in claim 16, wherein each of the internally threaded component and the externally threaded component is one of a shaft and a rod.

21. An anti-rotation apparatus, comprising:
an non-threaded elongate body configured to be disposed within a closed end of a cavity of an internally threaded component and having an end including a recess configured to receive an externally threaded component, wherein the end of the body is configured to frictionally engage a surface within the internally threaded component when the externally threaded component is coaxially driven against at least a portion of the recess to inhibit the rotation of the externally threaded component relative to the internally threaded component.

22. An anti-rotation apparatus as defined in claim 21, wherein the recess is substantially cone-shaped.

23. An anti-rotation apparatus as defined in claim 21, wherein the at least the portion of the recess against which the externally threaded component is driven is proximate to a peripheral portion of the elongate body.

24. An anti-rotation apparatus as defined in claim 21, wherein the elongate body is substantially cylindrical.
